(19) United States
(12) Patent Application Publication
(10) Pub. No.: US 2013/0221778 A1
(43) Pub. Date: Aug. 29, 2013

(54) DOUBLE DRIVE SHAFT MOTOR OF MAGNETIC FLUX MODULATION TYPE

(71) Applicant: DENSO CORPORATION, (US)

(72) Inventor: Shin KUSASE, Obu-shi (JP)

(73) Assignee: DENSO CORPORATION, Kariya-city (JP)

(21) Appl. No.: 13/771,940

(22) Filed: Feb. 20, 2013

(30) Foreign Application Priority Data
Feb. 29, 2012 (JP) 2012-043093

(51) Int. Cl. H02K 16/02; H02K 7/108

(52) U.S. Cl. CPC H02K 16/02; H02K 7/108
USPC 310/78; 310/114

(57) ABSTRACT

A double drive shaft motor has a field rotor supported by a first rotating shaft, a magnetic induction rotor supported by a second rotating shaft, a stator supported by a motor housing casing, a first rotation limitation section arranged between the motor housing casing and the first rotating shaft, a magnetic bi-directional clutch arranged between the motor housing casing and the second rotating shaft, and a magnetic bi-directional clutch arranged between the first rotating shaft and the second rotating shaft. Each magnetic bi-directional clutch operates by receiving a rotational force supplied from the corresponding rotating shaft without using any outside energy to maintain a connection state of the corresponding rotating shaft. The first rotation limitation section is a one-way clutch without requiring any electric control. This makes it possible to make plural operation states, for example, eight operation states from an engine start to an EV drive of a vehicle.

### CROSS-REFERENCE TO RELATED APPLICATION

This application is related to and claims priority from Japanese Patent Application No. 2012-43093 filed on Feb. 29, 2012, the contents of which are hereby incorporated by reference.

### BACKGROUND OF THE INVENTION

1. Field of the Invention

The present invention relates to double drive shaft motors of a magnetic flux modulation type for use in hybrid vehicles such as hybrid electric vehicles, equipped with an internal combustion engine, a main drive motor and a battery, driven by power of both the internal combustion engine and the main drive motor.

2. Description of the Related Art

There are conventional techniques relating to a hybrid vehicle drive system. For example, a patent document, Japanese patent laid open publication No. JP 2011-157068 discloses a conventional drive system used by a hybrid vehicle having an internal combustion engine, wheels, a reduction gear mechanism, a reduction ratio changing means, a clutch mechanism, a main drive motor and a power dividing means. The internal combustion engine generates mechanical power. The wheels are driven by the mechanical power (such as rotation power) generated by the internal combustion engine. The reduction gear mechanism adjusts the rotation speed between the internal combustion engine and the wheels. The clutch mechanism connects the wheels with the internal combustion engine, and disconnects the wheels from the internal combustion engine. The motor generates electromotive power. The power dividing means synthesizes, divides and distributes the mechanical power generated by the internal combustion engine and the electromotive power generated by the motor.

In the drive system disclosed in the patent document, Japanese patent laid open publication No. JP 2011-157068, because the motor, the clutch mechanism, the power dividing means, etc. are independently arranged to each other, the drive mechanism has a large size or an increased size. As a result, this increases a manufacturing cost and selects a specified type of vehicles, for example a vehicle having a front-engine rear-wheel-drive layout, on which the drive mechanism is mounted.

### SUMMARY

It is therefore desired to provide a double drive shaft motor of a magnetic flux modulation type having a compact-size drive mechanism having assembled components.

An exemplary embodiment provides a double drive shaft motor of a magnetic modulation type. The double dive shaft motor has a field rotor, a magnetic induction rotor, a stator, a first rotating shaft, a second rotating shaft, a motor housing casing, a first rotation limitation section and a second rotation limitation section. The field rotor has n pole pairs. That is, the number of the pole pairs in the field rotor is n (n is a natural number). The pole pairs are comprised of a north magnetic pole (N pole) and a south magnetic pole (S pole) which are alternately arranged in a circumferential direction of the field rotor. The magnetic induction rotor is concentrically arranged with a gap at one of a radially outer side and a radially inner side of the field rotor. The magnetic induction rotor has k soft magnetic members (k is a natural number). The k soft magnetic members make a magnetic path arranged at regular intervals with a gap in a circumferential direction of the magnetic induction rotor. The stator is concentrically arranged with a gap at one of a radially outer side of a first rotor and a radially inner side of a second rotor. The stator has a multi-phase winding having the number of pole pairs which is one of a sum and a difference between the number n and the number k, where the first rotor is one of the field rotor and the magnetic induction rotor which is arranged at a radially outer side. The second rotor is one of the field rotor and the magnetic induction rotor which is arranged at a radially inner side. The first rotating shaft is configured to support the field rotor. The second rotating shaft is configured to support the magnetic induction rotor. The motor housing casing is configured to rotatably support the first rotating shaft and the second rotating shaft. The first rotation limitation section is configured to allow the first rotating shaft to rotate in one rotation direction to the motor housing casing, and to limit the first rotating shaft to rotate in the other rotation direction to the motor housing casing. The second rotation limitation section is configured to switch between a neutral state and a locked state. The neutral state allows the second rotating shaft to rotate in both directions, namely bi-directions within the motor housing casing. The locked state prevents the second rotating shaft from rotating in one of the both directions within the motor housing casing.

The structure of the double drive shaft motor according to the exemplary embodiment of the present invention makes it possible to independently change the rotating speed of the first rotating shaft and the second rotating shaft. In addition to this feature, this structure makes it possible to connect the first rotating shaft with the second rotating shaft, and to disconnect the first rotating shaft from the second rotating shaft. When the double drive shaft motor of a magnetic modulation type according to the exemplary embodiment is used for a drive system of a hybrid electric vehicle, it is possible to add electromotive force to the power of an internal combustion engine mounted to the electric magnetic vehicle. Further, it is possible to regenerate electric power by receiving rotational force from the second rotational force. That is, the double drive shaft motor according to the exemplary embodiment of the present invention is a compact-size motor, and can use mechanical force and electromotive force easily. This makes it possible to provide the double drive shaft motor as a complex functional motor capable of executing a rotation speed changing control, power dividing and power synthesizing characteristics, and a motor generating characteristic. It is thereby possible to provide a driving system for a hybrid electric vehicle with a simple structure and a reduced side.

### BRIEF DESCRIPTION OF THE DRAWINGS

A preferred, non-limiting embodiment of the present invention will be described by way of example with reference to the accompanying drawings, in which:

FIG. 1 is a schematic cross section of a double drive shaft motor of a magnetic flux modulation type according to a first exemplary embodiment of the present invention;

FIG. 2 is a schematic cross section of a field rotor, a magnetic induction rotor and a stator in the double drive shaft motor shown in FIG. 1;

FIG. 3 is a schematic view showing an electrical connection of a stator winding of the stator in the double drive shaft motor shown in FIG. 1;

FIG. 4 is a schematic cross section of a clutch mechanism section and a clutch control section in a second rotation limitation section in the double drive shaft motor shown in FIG. 1;

FIG. 5A and FIG. 5B are schematic views showing a cross section of the clutch mechanism section and showing operation of the clutch mechanism section in the double drive shaft motor shown in FIG. 1;

FIG. 6 is a development view of the field rotor and the magnetic induction rotor, and shows the principle of magnetic modulation of the double drive shaft motor shown in FIG. 1;

FIG. 7A is a view showing the explanation of a rotational motion of the field rotor, the magnetic induction rotor and the stator in the double drive shaft motor shown in FIG. 1;

FIG. 7B is a view showing the explanation of the double drive shaft motor shown in FIG. 1 by using a collinear graph;

FIG. 8 is a view showing the explanation of the operation of the double drive shaft motor shown in FIG. 1 when the magnetic induction rotor is stopped;

FIG. 9A to FIG. 9E are views for explaining the principle of magnetic modulation on the basis of operation models (a), (b), (c), (d) and (e) of the double drive shaft motor shown in FIG. 1;

FIG. 10 is a view showing various operation modes (a) to (h) of the double drive shaft motor 1 shown in FIG. 1 mounted to a hybrid electric vehicle by using the collinear graph;

FIG. 11 is a schematic cross section of the double drive shaft motor of a magnetic flux modulation type according to a second exemplary embodiment of the present invention;

FIG. 12 is a schematic view showing an electrical connection of a stator winding in the double drive shaft motor shown in FIG. 11, and showing a method of supplying electric power to the double drive shaft motor shown in FIG. 11;

FIG. 13 is a view showing waveforms of three-phase currents to be supplied to the stator winding in the double drive shaft motor according to the second exemplary embodiment shown in FIG. 11;

FIG. 14 is a view explaining a magnetic flux flow generated when electric power is supplied to the stator winding in the double drive shaft motor according to the second exemplary embodiment shown in FIG. 11;

FIG. 15A is a schematic cross section of the magnetic bi-directional clutch in the rotation limitation section in the double drive shaft motor according to a third exemplary embodiment of the present invention;

FIG. 15B is a schematic cross section of the magnetic bi-directional clutch with the buffer member in the double drive shaft motor 1 according to the third exemplary embodiment shown in FIG. 15A; and

FIG. 16 is a schematic cross section showing the rotation limitation section in the double drive shaft motor shown according to a fourth exemplary embodiment of the present invention.

### DETAILED DESCRIPTION OF THE PREFERRED EMBODIMENTS

Hereinafter, various embodiments of the present invention will be described with reference to the accompanying drawings. In the following description of the various embodiments, like reference characters or numerals designate like or equivalent component parts throughout the several diagrams.

### First Exemplary Embodiment

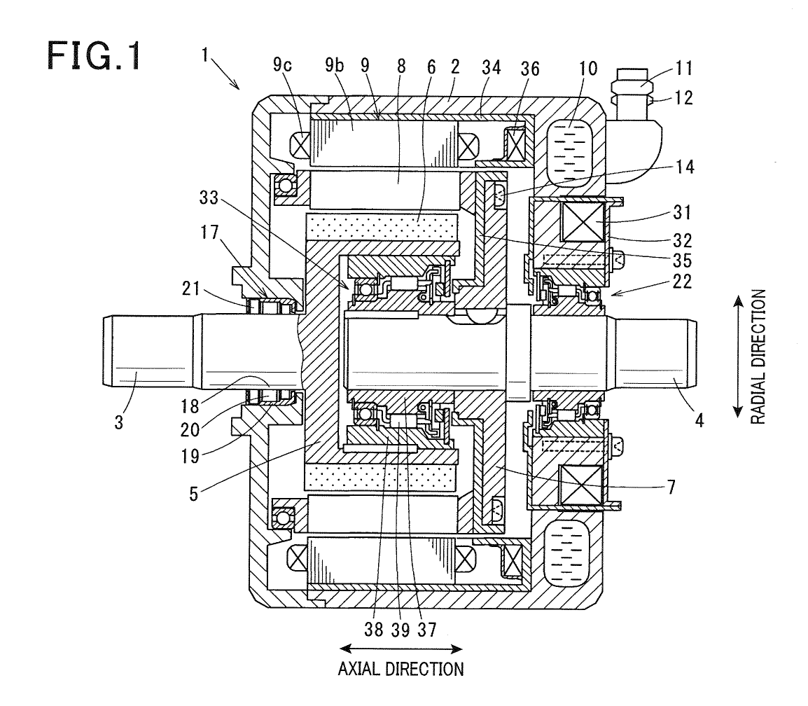

A description will be given of a double drive shaft motor 1 of a magnetic flux modulation type according to a first exemplary embodiment with reference to FIG. 1 to FIG. 10. The first exemplary embodiment will disclose the double drive shaft motor 1 mounted to a hybrid electric vehicle, and used as the drive system of the hybrid electric vehicle.

A description will now be given of the structure of the double drive shaft motor 1 of a magnetic flux modulation type.

FIG. 1 is a schematic cross section of the double drive shaft motor 1 of a magnetic flux modulation type according to the first exemplary embodiment. As shown in FIG. 1, the double drive shaft motor 1 has a motor housing casing 2, a first rotating shaft 3 (as an input shaft), a second rotating shaft 4 (as an output shaft), a field rotor 6, a magnetic induction rotor 8, a stator 9, a first rotation limitation section, a second rotation limitation section and a third rotation limitation section. The structure and operation of each of the first rotation limitation section, the second rotation limitation section and the third rotation limitation section will be explained later in detail.

The first rotating shaft 3 and the second rotating shaft 4 are supported by the motor housing casing 2. The field rotor 6 is supported by the first rotating shaft 3 through a hub 5. The hub 5 is made of magnetic material. The magnetic induction rotor 8 is arranged at a radially outer side of the field rotor 6. The magnetic induction rotor 8 is arranged concentrically with the field rotor 6. The magnetic induction rotor 8 is supported by the second rotating shaft 4 through a hub 7. The hub 7 is made of non-magnetic material. The stator 9 is arranged at a radially outer side of the magnetic induction rotor 8 through a gap and arranged concentrically with the magnetic induction rotor 8. The stator 9 is supported by the motor housing casing 2.

The first rotation limitation section is arranged between the motor housing casing 2 and the first rotating shaft 3. The second rotation limitation section is arranged between motor housing casing 2 and the second rotating shaft 4. The third rotation limitation section is arranged between the first rotating shaft 3 and the second rotating shaft 4.

The motor housing casing 2 is made of non-magnetic material such as aluminum. The motor housing casing 2 is fixed to an internal combustion engine (not shown) of the hybrid electric vehicle on which the double drive shaft motor 1 according to the first exemplary embodiment is mounted.

As shown in FIG. 1, the motor housing casing 2 has a structure in which a first part in a housing arm section has a thickness which is thicker than a thickness of a second part in the housing arm section. The first arm part supports the second rotating shaft 4. The second arm part supports the first rotating shaft 3. A cooling water supply passage 10 acts as a water jacket and is formed in the inside of the housing arm section.

A water inlet section 11 and a cooling water discharge section 12 are formed in the motor housing casing 2. Through the cooling water inlet section 11, cooling water is introduced into the cooling water supply passage 10. Through the cooling water discharge section 12, cooling water is discharged to the outside of the cooling water supply passage 10. The cooling water supply passage 10 is connected to a cooling water circuit (not shown) for the internal combustion engine through a pipe (not shown).

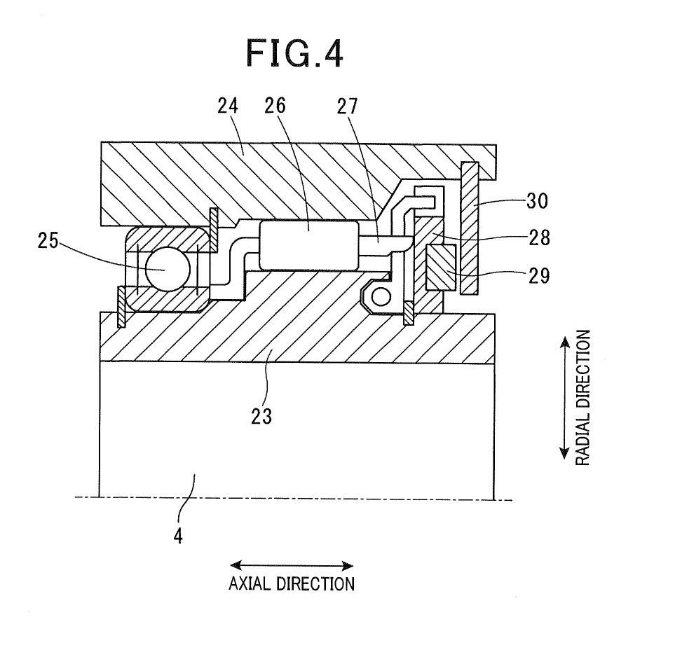

The first rotating shaft 3 is connected to an output shaft (or a crank shaft) of the internal combustion engine through an overdrive gearbox. The first rotating shaft 3 and the hub 5 are assembled together. The hub 5 supports the field rotor 6. The second rotating shaft 4 is connected to wheel shafts through a reduction gear shaft (not shown) and a moving direction changing gear which switches the moving direction of the wheels forward and backward. The hub 7 supporting the magnetic induction rotor 8 is meshed with an outer periphery of the second rotating shaft 4, as shown in FIG. 4. The first rotating shaft 3 and the second rotating shaft 4 are arranged on a same axial line.

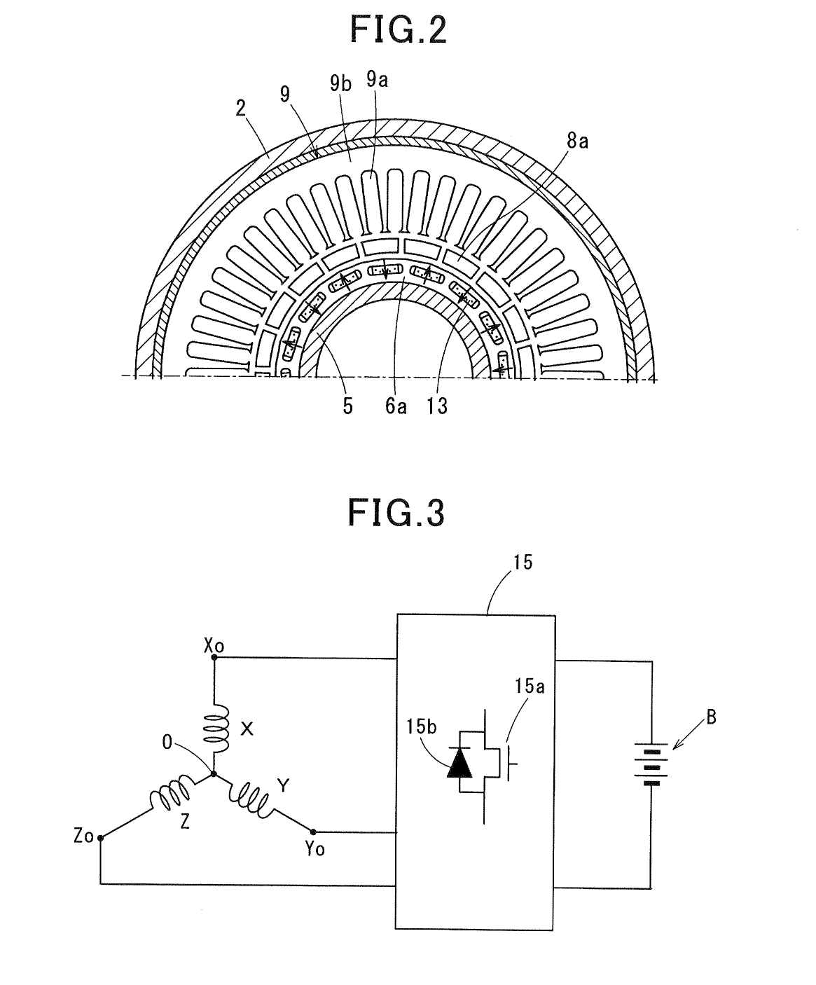

FIG. 2 is a schematic cross section of a field rotor, a magnetic induction rotor and a stator in the double drive shaft motor shown in FIG. 1.

As shown in FIG. 2, the field rotor 6 has a ring shaped rotor core 6a and sixteen rare-earth magnets 13 (for example, neodymium magnets). The ring shaped rotor core 6a is fitted to the outer periphery of the hub 5. The sixteen rare-earth magnets 13 are embedded in the ring shaped rotor core 6a.

For example, the ring shaped rotor core 6a is comprised of magnetic steel sheets which are stacked. The sixteen rare-earth magnets 13 are arranged at regular intervals along a circumferential direction of the ring-shaped rotor core 6a. The sixteen rare-earth magnets 13 are magnetized in a direction shown in a radial direction designated by arrows in FIG. 2. In particular, the adjacent rare-earth magnets 13 in a circumferential direction are magnetized in radially opposite directions to each other in order to make the north magnetic pole and the south magnetic pole in the adjacently arranged rare-earth magnets 13. The number n of pole pairs in the field rotor 6 is eight (n=8).

As shown in FIG. 2, the magnetic induction rotor 8 has a structure in which k soft magnetic members 8a (where, k=20 in the first exemplary embodiment) are arranged with gap at a same pitch in a circumferential direction. The k soft magnetic members 8a make a magnetic path. Each of the k soft magnetic members 8a is fixed to the hub 7 by non-metal fastening member 14 as an insulator (see FIG. 1).

As shown in FIG. 2, the stator 9 is comprised of a stator core 9b and a stator winding 9c (see FIG. 1) wound around the stator core 9b. A plurality of slots 9a is formed at a same interval in a circumferential direction of the stator core 9b. The stator 9 is fixed to the inner periphery of the motor housing casing 2.

The stator core 9b is comprised of magnetic steel sheets having a ring shape which are stacked. The stator winding 9c is a multi-phase winding. The number of pole pairs in the multi-phase winding is m. The number m of pole pairs is a sum (n+k) or a subtraction (n−k) of the number n of pole pairs of the field rotor 6 and the number k of pole pairs of the magnetic induction rotor 8. Specifically, the stator winding 9 is a three-phase winding wound around the overall periphery of the stator core 9b at a pitch which divides the overall circumference of the stator core 9b by 24. That is, the number m of pole pairs is 12 (m=12).

FIG. 3 is a schematic view showing an electrical connection (Y connection) of the stator winding 9c in the double drive shaft motor 1 according to the first exemplary embodiment shown in FIG. 1.

As shown in FIG. 3, the three-phase winding is a y-connection of three phase (X phase, Y phase and Z phase) wires which are different in phase by 120°. A terminal Xo of the X phase wire, a terminal Yo of the Y phase wire and a terminal Zo of the Z phase wire are connected to a high voltage battery B mounted to the hybrid electric vehicle through an inverter 15. Those terminals Xo, Yo and Zo are opposite terminals to the neutral point O.

The inverter 15 is an electric power conversion device capable of transforming DC power to AC power. For example, the inverter 15 is comprised of a plurality of transistors 15a and diodes 15b. Each transistor 15a is reversely connected to the corresponding diode 15b. An inverter electric control unit (inverter ECU, not shown) executes the operation control of the inverter 15. The inverter ECU is connected to a vehicle ECU (not shown).

A first rotation limitation section has a one-way clutch 17. The one-way clutch 17 allows the first rotating shaft 3 (as the input shaft) to rotate in a power rotating direction, and to prevent the first rotation limitation section from rotating in opposite direction of the power rotating direction.

Throughout the description, the power rotating direction is a direction to which the first rotating shaft 3 rotates by the power transmitted from an internal combustion engine of the hybrid electric vehicle.

On the other hand, the one-way clutch 17 is a known device. A description will now be given of a structure of the one-way clutch 17.

As shown in FIG. 1, the one-way clutch 17 is comprised of an inner ring 18, an outer ring 19 and a roller 20. The first rotating shaft 3 acts as the inner ring 18 in the one-way clutch 17. The outer ring 19 is fixed to the inner periphery of the motor housing casing 2. The roller 20 is arranged between the inner ring 18 and the outer ring 19.

When a rotating power in an opposite direction to the power rotating direction is supplied to the first rotating shaft 3, the roller 20 is mated with a wedge-shaped gap formed between the inner ring 18 and the outer ring 19. This structure makes it possible to prevent the first rotating shaft 3 from rotating in an opposite direction to the power rotating direction. A roller bearing 21 is arranged adjacent to the one-way clutch 17 between the first rotating shaft 3 and the motor housing casing 2.

The first rotating shaft 3 is rotatably supported by motor housing casing 2 through the roller bearing 21.

The second rotation limitation section switches between a neutral state and a locked state. The neutral state allows the second rotating shaft 4 (as the output shaft) to rotate in a forwardly rotating direction and a reversely rotating direction. The reversely rotating direction is opposite to the forwardly rotating direction. The locked state prevents the second rotating shaft 4 to rotate in both the forwardly rotating direction and the reversely rotating direction. That is, the locked state allows the second rotating shaft 4 to rotate in the forwardly rotating direction or the reversely rotating direction only. Throughout the description, the forwardly rotating direction of the second rotating shaft 4 corresponds to a forward movement of the hybrid electric vehicle. The reversely rotating direction of the second rotating shaft 4 corresponds to a backward movement of the hybrid electric vehicle. The second rotation limitation section corresponds to a magnetic bi-directional clutch 22. The magnetic bi-directional clutch 22 releases the neutral state of the second rotating shaft 4 by a magnetic force generated by an electrical magnet. The magnetic bi-directional clutch 22 switches the second rotating shaft 4 into the locked state by using the rotational force of the second rotating shaft 4 after releasing the second rotating shaft 3 from the neutral state by the magnetic force generated by the electromagnet.

The magnetic bi-directional clutch 22 is comprised of a clutch mechanism section, a clutch control section and the electrical magnet.

FIG. 4 is a schematic cross section of the clutch mechanism section and the clutch control section which form the second rotation limitation section in the double drive shaft motor 1 shown in FIG. 1.

As shown in FIG. 4, the clutch mechanism section is comprised of an inner ring 23, an outer ring 24, a bearing 25, a plurality of rollers 26, a supporting section 27 and a switch spring (not shown).

The inner ring 23 is mated with the outer periphery of the second rotating shaft 4. The outer ring 24 is fixed to the inner periphery of the motor housing casing 2. The bearing 25 supports both the inner ring 23 and the outer ring 24 and to allow the inner ring 23 and the outer ring 24 to rotate relative to each other. The rollers 26 are arranged between the inner ring 23 and the outer ring 24. The supporting section 27 supports the rollers 26. The switch spring supports the supporting section 27 by its spring force.

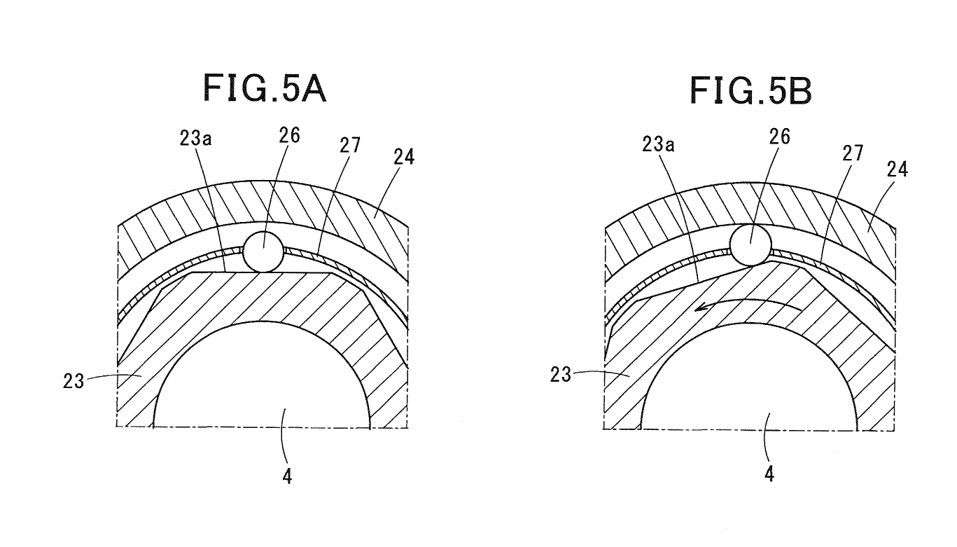

FIG. 5A and FIG. 5B are schematic views showing a cross section of the clutch mechanism section and showing operation of the clutch mechanism section in the double drive shaft motor 1 shown in FIG. 1.

As shown in FIG. 5A and FIG. 5B, the outer peripheral surface of the inner ring 23 has a polygonal shape. Each surface of the inner ring 23 having a polygonal shape is called a cam surface 23a. As shown in FIG. 5A, each roller 26 is supported at the central section of the cam surface 23a by the supporting section 27. The switch spring (not shown) provides a supporting force to the roller 26.

When each roller 26 is supported at the corresponding central section of the cam surface 23a, the inner ring 23 and the outer ring 24 rotate relative to each other because there is a gap between the outer ring 24 and the roller 26. The state in which each roller 26 is supported at a central part of the corresponding cam surface 23a is called the neutral state. During the neutral state, the inner ring 23 and the outer ring 24 can rotate relative to each other.

As shown in FIG. 4, the clutch control section is comprised of an armature 28 made of magnetic material, a friction section 29, and a slide section 30 made of non-magnetic material. The armature 28 is mated with the supporting section 27. The friction section 29 is attached to the armature 28. The slide section 30 is arranged to face the armature 28 with a gap between the slide section 30 and the friction section 29. The slide section 30 is fixed to the outer ring 24.

In the clutch control section, the armature 28 is attracted to the slide section 30 (toward the right side in FIG. 4) by magnetic force generated by the electrical magnet. The friction section 29 fixed to the armature section 28 is moved to the slide section 30, and is finally in contact with the slide section 30 by the attraction force. Because a friction force is generated between the slide section 30 and the friction section 29, the armature 28 having the friction section 29 prevents the movement of the supporting section 27. That is, the clutch control section can release the neutral state of the clutch mechanism section by the magnetic force of the electrical magnet.

When a relative rotation is generated between the inner ring 23 and the outer ring 24 after the clutch control section releases the clutch mechanism section from the neutral state, as shown in FIG. 5B, a phase of each roller 26 to the inner ring 23 is changed. That is, the roller 26 is moved from the central section to the edge section of the cam surface 23a, and the roller 26 is mated between the cam surface 23a and the inner peripheral surface of the outer ring 24. This prevents the rotation of the inner ring 23, namely, prevents the rotation of the second rotating shaft 4. As shown in FIG. 5B, this prevents the inner ring 23 from rotating in the direction designated by the arrow in FIG. 5B (in a counterclockwise direction).

When the relative rotation between the inner ring 23 and the outer ring 24 is generated in an opposite direction to the direction shown in FIG. 5B, it is possible to prevent the inner ring 23 from rotating in the right direction (as the clockwise direction) shown in FIG. 5B.

The limitation state which prevents the relative rotation between the inner ring 23 and the outer ring 24 by the roller 26, in other words, the state which allows the second rotating shaft 4 to rotate in the forward rotation direction or in the backward rotation direction only is called the locked state.

As shown in FIG. 1, the electrical magnet has an excitation coil 31 and generates magnetic force when an outside power source supplies electric power to the excitation coil 31 supported by the motor housing casing 2.

Further, as shown in FIG. 1, the motor housing casing 2 is equipped with a magnetic induction yoke 32. The magnetic induction yoke 32 introduces magnetic force generated by the excitation coil 31 into the clutch control section when electric power is supplied to the excitation coil 32.

The magnetic induction yoke 32 is comprised of an outer peripheral yoke, an outer surface yoke, and an inner surface yoke. The outer peripheral yoke penetrates the motor housing casing 2 in a thickness direction (the right and left sides in FIG. 1) thereof along the outer periphery of the excitation coil 31. The outer surface yoke extends in a radially inner direction from the right side of the outer peripheral yoke shown in FIG. 1 along the outer peripheral surface of the motor housing casing 2. The radially inner end of the outer surface yoke is in contact with the axial end surface of the outer ring 24 in an axial direction from the right side of the outer peripheral yoke to the outer peripheral surface of the motor housing casing 2. The inner surface yoke extends from the left end of the outer surface yoke to a radially inner direction along the inner peripheral surface of the motor housing casing 2. The radially inner end of the inner surface yoke is arranged close to the slide section 30. The inner ring 23 and the outer ring 24 of the clutch structure section are made of magnetic material.

The third rotation limitation section switches between a direct connection state and a disconnection state. The direct connection state connects the first rotating shaft 3 with the second rotating shaft 4. The disconnection state disconnects the first rotating shaft 3 from the second rotating shaft 4.

The third rotation limitation section corresponds to a magnetic bi-directional clutch 33. The magnetic bi-directional clutch 33 releases the disconnection state between the first rotating shaft 3 and the second rotating shaft 4 by a magnetic force generated by an electrical magnet, and switches to the direct connection state between the first rotating shaft 3 and the second rotating shaft 4 by using the rotational force of the first rotating shaft 3 after releasing the disconnection state between the first rotating shaft 3 and the second rotating shaft 4 by the magnetic force generated by the electromagnet.

Because the third rotation limitation section has the same structure of the second rotation limitation section, the explanation for the third rotation limitation section is omitted here for brevity.

A description will now be given of a mechanism of the magnetic bi-directional clutch 33 to provide a magnetic field to the clutch control section. This mechanism of the magnetic bi-directional clutch 33 is different from the mechanism of the magnetic bi-directional clutch 22 to supply the magnetic field.

The magnetic bi-directional clutch 33 uses a magnetic induction yoke. As shown in FIG. 1, the magnetic induction yoke used in the magnetic bi-directional clutch 33 is comprised of an outer yoke 34 and an inner yoke 35. The outer yoke 34 is arranged at the side of the stator 9. The inner yoke 35 is arranged next to the field rotor 6 and the magnetic induction rotor 8.

As shown in FIG. 1, the outer yoke 34 is arranged between the motor housing casing 2 and the stator core 9b. The outer yoke 34 further extends from the radially inner end (at the right side) toward the radially inner direction along the arm section of the motor housing casing 2 where the cooling water supply passage 10 is formed. The outer yoke 34 further extends from the right side toward the stator side (at the left side) in an axial direction. The part of the outer yoke 34 which extends from the right side toward the stator 9 is called the “radially inner end” of the outer yoke 34.

The inner yoke 35 is fixed to the hub 7. The hub 7 supports the magnetic induction rotor 8. The outer peripheral end in a radial direction of the inner yoke 35 is arranged with a gap to face the radially inner side of the outer yoke 34. The inner peripheral end in a radial direction of the inner yoke 35 is arranged to close a slide section (not shown).

As shown in FIG. 1, the excitation coil 36 of the electromagnet is arranged in a concave section formed in the outer yoke 34 at the right side thereof. When electric power is supplied to the excitation coil 36, the electromagnet generates magnetic force.

When electric power is supplied to the excitation coil 36, magnetic flux flows in a magnetic flux passage comprised of the outer yoke 34, the stator core 9b, the magnetic induction rotor 8, the field rotor 6 and the inner yoke 35 in the magnetic bi-directional clutch 33.

Like the operation of the magnetic bi-directional clutch 22 as previously explained, the clutch control section operates by the magnetic flux flowing through the magnetic flux passage. As a result, when a difference in rotation speed is generated between an inner ring 37 fixed to the second rotating shaft 4 and the outer ring 38 fixed to the hub 5 of the first rotating shaft 3, roller 39 is mated with gap between the inner peripheral surface of the outer ring 38 and the cam surface of the inner ring 37, and as a result, this prevents relative rotation between the inner ring 37 and the outer ring 38.

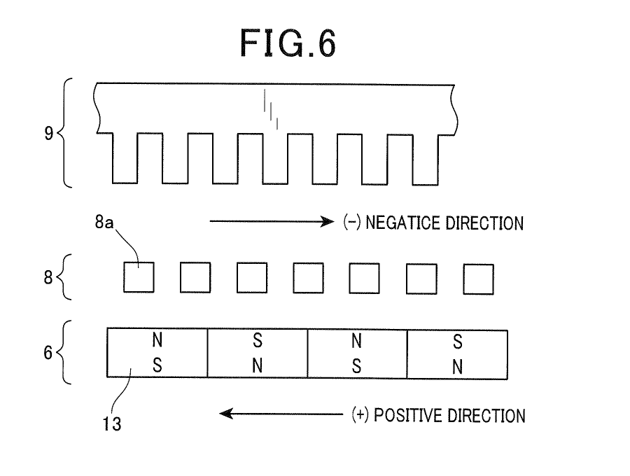

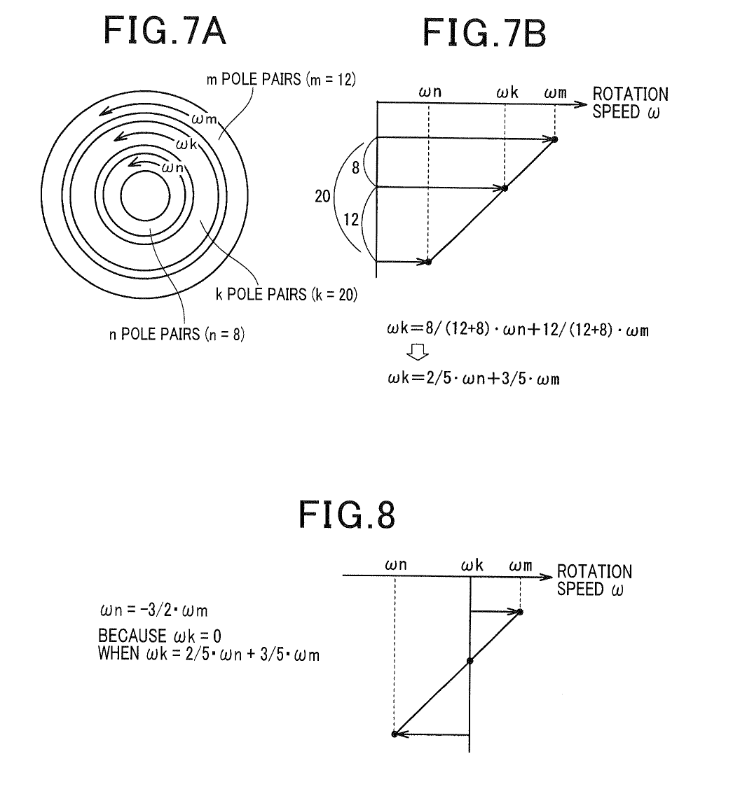

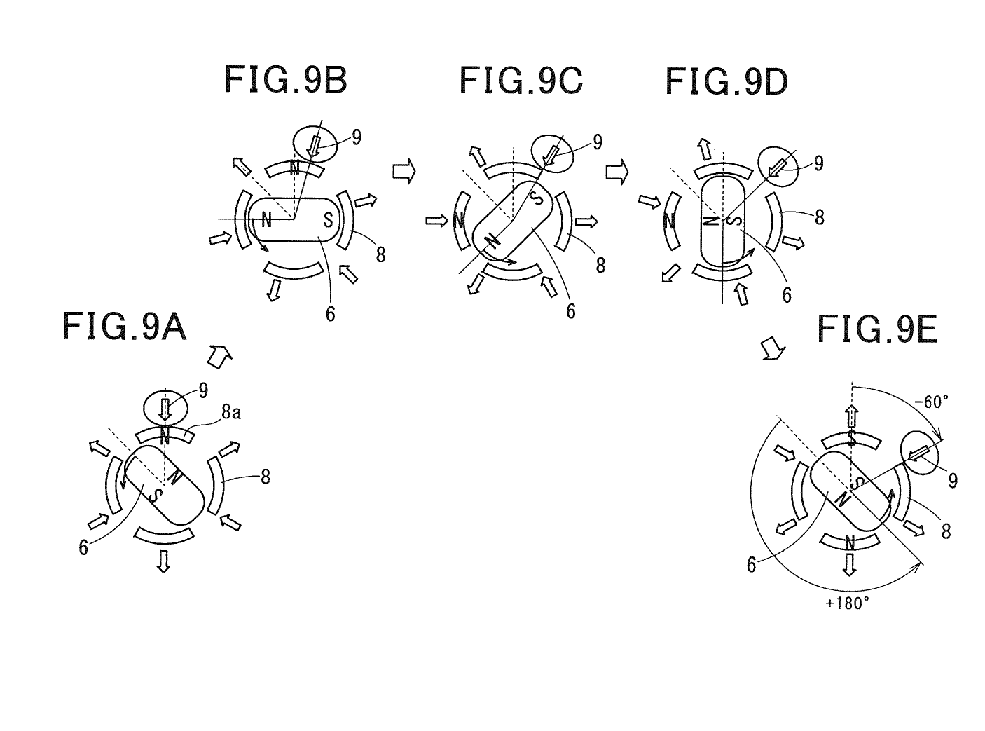

Next, a description will now be given of the basic operation of the magnetic circuit formed in the double drive shaft motor 1 according to the first exemplary embodiment of the present invention with reference to FIG. 6, FIG. 7A, FIG. 7B, FIG. 8, and FIG. 9A to FIG. 9E.

FIG. 6 is a development view of the field rotor 6 and the magnetic induction rotor 8, and shows the principle of magnetic modulation of the double drive shaft motor 1 according to the first exemplary embodiment shown in FIG. 1. That is, FIG. 6 shows the structure of the double drive shaft motor 1 in which the field rotor 6 has sixteen magnets 13 arranged in a circumferential direction of the field rotor 6 to form eight pole pairs. The stator 9 has a three phase winding (omitted from FIG. 6) wound to make twelve pole pairs. The magnetic induction rotor 8 has twenty soft magnetic members 8a arranged between the field rotor 6 and the stator 9 at regular intervals along a circumferential direction. FIG. 6 also shows a development view in which the stator 9, the field rotor 6 and the magnetic induction rotor 8 are arranged in parallel along a line direction for brevity. In FIG. 6, the magnetic induction rotor 8 is stopped in operation for brevity.

When the field rotor 6 moves toward the positive direction designated by reference character “+” and the arrow in FIG. 6, magnetic flux flows from the field rotor 6 to the stator 9 through the magnetic induction rotor 8. In this case, the magnetic induction rotor 8 acts as a filter of the magnetic flux. That is, because the twenty soft magnetic members 8a as good magnetic conductors and the twenty gaps as non-magnetic conductors are alternately arranged, a sum or a difference of the frequency component of the eight pole pairs of the field rotor 6 and the frequency component of the twenty pole pairs of the magnetic induction rotor 8 passes through the magnetic induction rotor 8 to the stator 9.

Accordingly, when the stator 9 has the winding of the number of pole pairs capable of receiving the sum or the difference in frequency components between the eight pole pairs and the twenty pole pairs, that is, when the stator 9 has a multi-phase winding of twenty eight pole pairs or twelve pole pairs, it is possible to transmit magnetic energy between the field rotor 6 and the magnetic induction rotor 8 with high efficiency. It is possible to realize the double drive shaft motor 1 of a magnetic modulation type in which electromagnetic force is transmitted between the stator 9, the field rotor 6 and the magnetic induction rotor 8 with high efficiency. It is thereby possible for the double drive shaft motor 1 to operate as a planetary gear of a mechanical type, namely, as a planet gear mechanism of a known type.

FIG. 7A is a view showing the explanation of a rotational motion of the field rotor 6, the magnetic induction rotor 8 and the stator 9 in the double drive shaft motor 1 shown in FIG. 1. FIG. 7B is a view showing the explanation of the double drive shaft motor 1 shown in FIG. 1 by using a collinear graph. In other words, FIG. 7A shows a rotating motion of the field rotor 6, a rotating motion of the magnetic induction rotor 8 and a rotating magnetic field generated by the stator 9. A rotation speed of the field rotor 6 is designated by reference character “ωn”, a rotation speed of the magnetic induction rotor 8 is designated by reference character “ωk” and a rotation speed of a rotating magnetic field generated by the stator 9 is designated by reference character “ωm”. These rotation speeds ωn, ωk and ωm can be designated by a relationship shown in FIG. 7B. That is, as shown in FIG. 7B, these rotation speeds ωn, ωk and ωm can be plotted on the upper straight line of a trapezoid having a predetermined ratio. The reason why these rotation speeds ωn, ωk and ωm can be plotted on the upper straight line of the trapezoid is to have the structure in which the stator 9 is operated on the basis of a difference in frequency component between the field rotor 6 and the magnetic induction rotor 8, as previously explained and shown in FIG. 6. That is, because a product of each of the rotation speeds ωn, ωk and ωm and the number of pole pairs corresponds to the frequency component, it can be obtained by the following equation (1):

$$\begin{matrix}ω k = \{ 8 / ( 12 + 8 ) \} \times ω n + \{ 12 / ( 12 + 8 ) \} \times ω m \\ = ( 2 / 5 ) \times ω n + ( 3 / 5 ) \times ω m .\end{matrix} \qquad ( 1 )$$

The relationship designated by the equation (1) indicates that the rotation speed ωn of the field rotor 6, the rotation speed ωk of the magnetic induction rotor 8, and the rotation speed corn of the rotating magnetic field generated by the stator 9 can be arranged on a straight line.

A description will now be given of an operation example when the magnetic induction rotor 8 is stopped, namely, does not rotate. When the magnetic induction rotor 8 does not rotate, because the rotating speed ωk of the magnetic induction rotor 8 is zero (ωk=0), the rotation speed ωn becomes −(3/2)×ωm, that is, ωn=−(3/2)×ωm.

FIG. 8 is a view showing the explanation of the operation of the double drive shaft motor 1 shown in FIG. 1 when the magnetic induction rotor 8 is stopped.

That is, it can be understand on the basis of a collinear graph shown in FIG. 8 that the rotating direction of the field rotor 6 is opposite to the rotating direction of the rotating magnetic field generated by the stator 9.

A description will now be given of an explanation of magnetic phenomenon by using a simple model when the number of pole pairs in each of the field rotor 6, the magnetic induction rotor 8 and the stator 9 is decreased.

FIG. 9A to FIG. 9E are views for explaining the principle of magnetic modulation on the basis of various operation models of the double drive shaft motor 1 shown in FIG. 1.

FIG. 9A to FIG. 9E show a model having a structure in which the field rotor 6 has a single pole pair (n=1), the magnetic induction rotor 8 has four pole pairs (k=4) and the stator has three pole pairs (m=3). FIG. 9A to FIG. 9E show the change of the rotation angle of the field rotor 6 when the rotating magnetic field generated by the stator 9 is changed from the state shown in FIG. 9A to the state shown in FIG. 9E.

First, as shown in FIG. 9A, when the magnetic field is generated in the stator 9, the soft magnetic member 8a in the magnetic induction rotor 8, which is near the magnetic field designated by the arrow enclosed by a circle, is induced to the N pole. The N pole of the field rotor 6 near the soft magnetic member 8a is repelled by the N pole of the soft magnetic member 8a, and starts thereby to rotate in a counterclockwise direction.

Next, as shown in FIG. 9B, when the magnetic field of the stator 9 slightly rotates in a clockwise direction, although the strength of the N pole generated in the soft magnetic member 8a of the magnetic induction rotor 8 becomes weak, the soft magnetic member 8a of the magnetic induction rotor 8 still has the N pole. Accordingly, the field rotor 6 is rotated to a position so that the field rotor 6 becomes perpendicular to the soft magnetic member 8a of the magnetic induction rotor 8.

Further, when the field rotor 6 is rotated to the state shown in FIG. 9C, because the soft magnetic member 8a of the magnetic induction rotor 8, which faces the N pole of the field rotor 6, is induced to become a N pole, the field rotor 6 is greatly repulsed from the N pole of the soft magnetic member 8a. As a result, the field rotor 6 is further rotated in a counterclockwise direction.

As previously explained, when the rotating magnetic field generated by the stator 9 is moved while the magnetic induction rotor 8 is fixed, the field rotor 6 is rotated in the counterclockwise direction which is opposite to the rotation direction of the rotating magnetic field. As shown in the collinear graph shown in FIG. 8, it can be understood that the rotation direction of the rotating magnetic field generated by the stator 9 is opposite to the rotating direction of the field rotor 6.

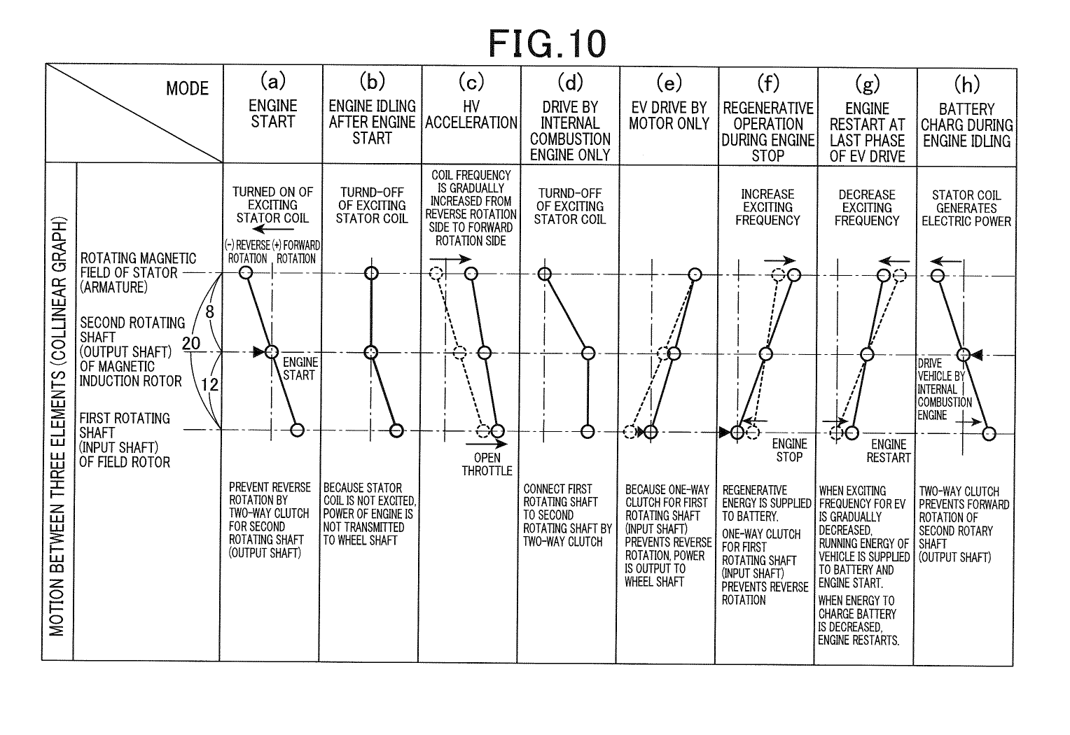

Next, a description will now be given of the operation of the double drive shaft motor 1 of a magnetic flux modulation type according to the first exemplary embodiment when the double drive shaft motor 1 is used in the hybrid electric vehicle with reference to FIG. 10.

FIG. 10 is a view showing various operation modes (a) to (h) of the double drive shaft motor 1 mounted to a hybrid electric vehicle by using the collinear graph. That is, FIG. 10 shows a collinear graph between each of the operation modes of the hybrid electric vehicle and the operation of the double drive shaft motor 1.

### (Engine Start)

As shown in the column (a) of the collinear graph shown in FIG. 10, when the magnetic bi-directional clutch 22 limits the reverse rotation of the second rotating shaft 4, and the rotating magnetic field generated by the stator 9 is driven in a reversely rotating direction, the forward rotation power (or the positive rotation power) is supplied to the internal combustion engine of the hybrid electric vehicle, and the internal combustion engine thereby starts to rotate.

(Engine Idling after Engine Start)

As shown in the column (b) of the collinear graph shown in FIG. 10, the second rotating shaft 4 does not rotate when no electric power is supplied to the three phase winding of the stator 9 during an engine idling state of the internal combustion engine after the engine starts. It is thereby possible to continue the engine idling state without supplying any electric power.

### (HV Acceleration)

As shown in the column (c) of the collinear graph shown in FIG. 10, when an opening ratio of a throttle is increased in order to increase the rotation speed of the internal combustion engine, and the inverter 15 increases the rotation speed of the rotating magnetic field generated by the stator 9, the rotation speed of the magnetic induction rotor 8, the rotation speed of the second rotating shaft 4 are thereby increased.

### (Drive by Internal Combustion Engine Only)

As shown in the column (d) of the collinear graph shown in FIG. 10, the magnetic bi-directional clutch 33 operates to directly connect the first rotating shaft 3 to the second rotating shaft 4. Specifically, a current to be supplied to each phase wire of the stator 9 has a same phase component (zero phase) within a short time period. This makes it possible to enter the clutch mechanism section in the magnetic bi-directional clutch 33 into the direct connection state, and the first rotating shaft 3 is thereby connected to the second rotating shaft 4. After obtaining the direct connection between the first rotating shaft 3 and the second rotating shaft 4, the supply of electric power to the stator winding 9c of the stator 9 is stopped. The hybrid electric vehicle runs by the power generated by the internal combustion engine only.

Even if no current flows in the stator winding 9c, it is possible to maintain the direct connection state between the first rotating shaft 3 and the second rotating shaft 4 because the clutch mechanism section of the magnetic bi-directional clutch 33 has a roller type.

### (EV Drive by Motor Only)

As shown in the column (e) of the collinear graph shown in FIG. 10, the opening ratio of the throttle is decreased to stop the internal combustion engine, and the stator 9 generates the rotating magnetic field which is higher than the rotation speed of the second rotating shaft 4 which is connected to the wheels of the hybrid electric vehicle. This control makes it possible to generate the state in which the first rotating shaft 3 connected to the internal combustion engine rotates in a direction which is opposite to the rotation direction of the second rotating shaft 4. At this time, the one-way clutch 17 prevents the reverse rotation of the first rotating shaft 3. That is, the first rotating shaft 3 is stopped. This means that the rotating magnetic field generated by the stator 9 drives the second rotating shaft 4 only, and the hybrid electric vehicle executes the EV drive, namely, runs by the power generated by the double drive shaft motor 1 only.

### (Regenerative Operation During Engine Stop)

As shown in the column (f) of the collinear graph shown in FIG. 10, like the stator 9 shown in FIG. 10E, the stator 9 generates the rotating magnetic field which is higher than the rotation speed of the second rotating shaft 4 which is connected to the wheels of the hybrid electric vehicle. At this time, the first rotating shaft 3 continues to stop because the one-way clutch 17 prevents the reverse rotation of the first rotating shaft 3, which is opposite to the usual powered rotation direction. This makes it possible to supply regenerative energy generated by the wheel shaft to the battery B through the stator winding 9c while the internal combustion engine is stopped.

### (Engine Restart at Last Phase of EV Drive)

As shown in the column (g) of the collinear graph shown in FIG. 10, the stator 9 generates the rotating magnetic field whose rotation speed is greatly smaller than the rotation speed of the wheel shaft of the hybrid electric vehicle. Like a part of a seesaw motion, the rotation speed of the internal combustion engine is slowly increased from zero and the internal combustion engine starts to rotate in the forward rotation direction. That is, the internal combustion engine is restarted while the hybrid electric vehicle drives.

### (Charging During Idling)

As shown in the column (h) of the collinear graph shown in FIG. 10, the magnetic bi-directional clutch 22 limits the forward rotation of the second rotating shaft 4. In this case, the stator 9 generates the rotating magnetic field which rotates in a reversely rotating direction, and the electrical generation can be executed without any problem.

As previously described, the double drive shaft motor 1 according to the first exemplary embodiment independently changes the rotation speed of the first rotating shaft 3 and the rotation speed of the second rotating shaft 4, respectively, and makes the connection state and the disconnection state between the first rotating shaft 3 and the second rotating shaft 4.

Further, the double drive shaft motor 1 supplies the electromotive power to the first rotating shaft 3 and the second rotating shaft 4, and generates electric power by receiving the rotation power supplied from the second rotating shaft 4. That is, although the double drive shaft motor 1 is a compact-size motor, the double drive shaft motor 1 freely switches between the mechanical power and the electromotive power bi-directionally, namely, in both directions. This makes it possible to provide a complex function motor having a complex function, a speed changeable function, a power dividing function, a power synthesizing function and a motor generator function. To use the double drive shaft motor 1 according to the first exemplary embodiment having the various functions previously described provides a simple vehicle drive system and a miniaturization.

### Second Exemplary Embodiment

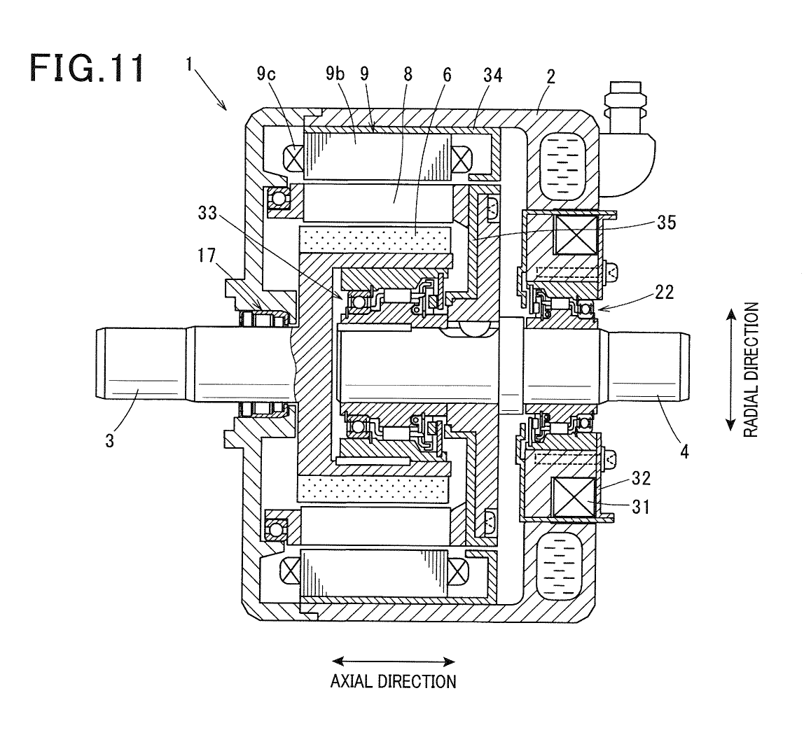

A description will be given of the double drive shaft motor 1 according to the second exemplary embodiment with reference to FIG. 11 to FIG. 14.

FIG. 11 is a schematic cross section of the double drive shaft motor 1 of a magnetic flux modulation type according to the second exemplary embodiment of the present invention.

As shown in FIG. 11, the magnetic bi-directional clutch 33 in the double drive shaft motor 1 according to the second exemplary embodiment does not have the excitation coil 36. That is, the excitation coil 36 is eliminated from the electromagnet in the magnetic bi-directional clutch 33. Instead of the excitation coil 36 eliminated from the electromagnet, the stator winding 9c of the stator 9 is used when the magnetic bi-directional clutch 33 operates.

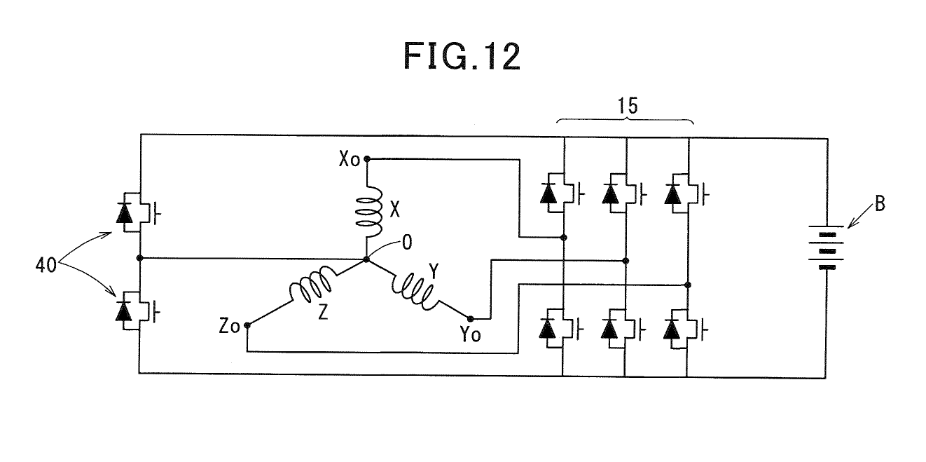

FIG. 12 is a schematic view showing an electrical connection of the stator winding 9c in the double drive shaft motor 1 according to the second exemplary embodiment shown in FIG. 11. That is, FIG. 12 shows a method of supplying electric power to the double drive shaft motor 1.

As shown in FIG. 12, semiconductor switching elements 40 at both positive and negative sides are connected, at a positive side and a negative side, respectively, to the neutral point O of the stator winding 9c connected in a Y connection (or a start connection). This connection allows a current to flow into the stator winding 9c through the neutral point O in addition to the three-phase terminals Xo, Yo and Zo.

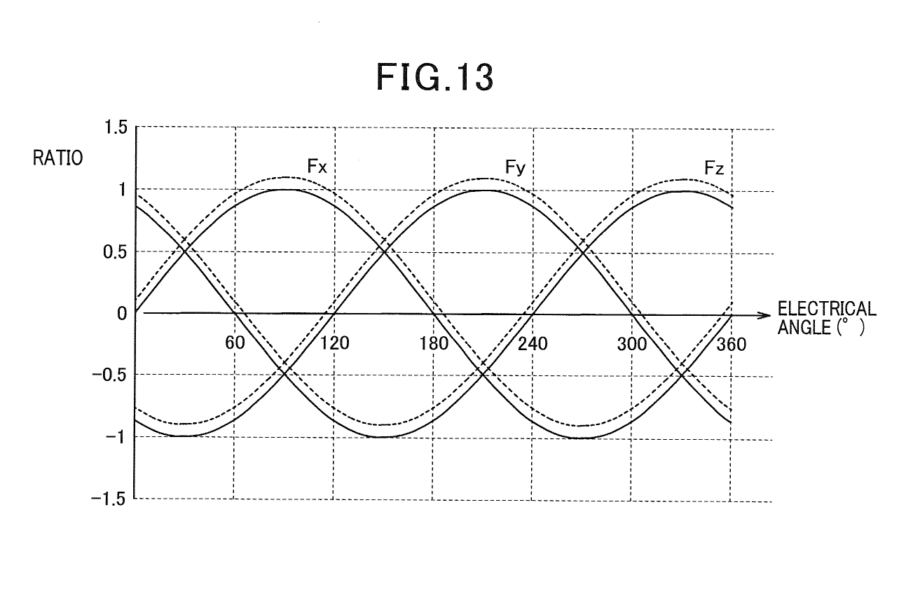

FIG. 13 is a view showing waveforms of three-phase currents to be supplied to the stator winding in the double drive shaft motor 1 according to the second exemplary embodiment shown in FIG. 11.

A direct-current component, that is, a zero phase component designated by the dotted lines shown in FIG. 13 is supplied to the three-phase stator winding of the stator 9. On the other hand, the solid lines indicate three phase wave currents with a phase separation of one-third cycle (120°). Reference characters Fx, Ry and Fz correspond to three phase wave currents which are shifted by one-third cycle) (120°), respectively.

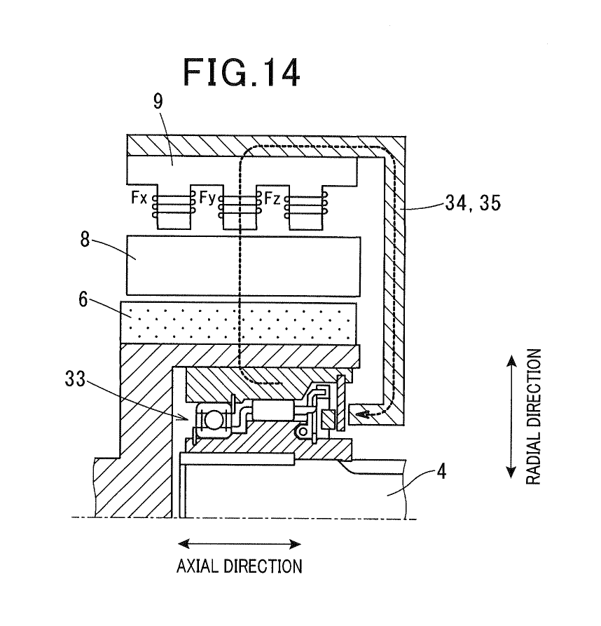

FIG. 14 is a view explaining a magnetic flux flow generated when electric power is supplied to the stator winding 9c in the double drive shaft motor 1 according to the second exemplary embodiment shown in FIG. 11. As shown in FIG. 14, the magnetic flux flows in the route designated by the dotted line. The route is comprised of the stator 9, the magnetic induction rotor 8, the magnetic bi-directional clutch 33 and the magnetic induction yoke comprised of the outer yoke 34 and the inner yoke 35.

The flow of the magnetic flux in the route makes it possible to allow the clutch control section to operate. The clutch mechanism section is thereby entered into the direct-connection state. That is, it is possible to operate the magnetic bi-directional clutch 33 by changing the control waveform of the inverter 15 (see FIG. 12).

### Third Exemplary Embodiment

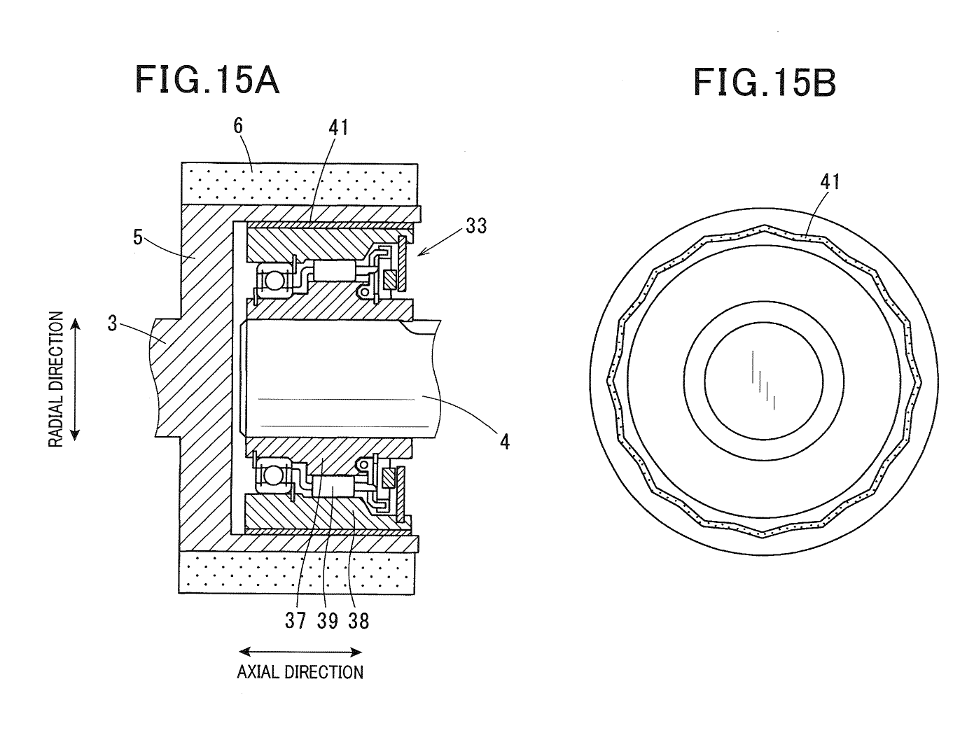

A description will be given of the double drive shaft motor 1 according to the third exemplary embodiment with reference to FIG. 15A and FIG. 15B.

FIG. 15A is a schematic cross section of the magnetic bi-directional clutch 33 in the double drive shaft motor 1 according to the third exemplary embodiment of the present invention.

As shown in FIG. 15A, a buffer member 41 (or a cushion member) made of hard rubber is assembled to the magnetic bi-directional clutch 33 as the clutch mechanism section. The buffer member 41 acts as an impact buffer section. That is, as shown in FIG. 15A, the buffer member 41 is arranged between the outer ring 38 and the hub 5. By the way, as previously described, the hub 5 is assembled together with the first rotating shaft 3. This structure having the buffer member 41 makes it possible to avoid damage caused by fast engaging of the roller 39 and the impact caused by the fast engaging of the roller 39. This expands the life of the clutch section, and makes it possible to smoothly execute the connection and the disconnection between the first rotating shaft 3 and the second rotating shaft 4.

FIG. 15B is a schematic cross section of the magnetic bi-directional clutch 33 with the buffer member 41 in the double drive shaft motor 1 according to the third exemplary embodiment shown in FIG. 15A. As shown in FIG. 15B, when the buffer member 41 has a polygonal shape along a circumferential direction of the field rotor 6, it is possible to prevent the buffer member 41 from sliding or being moved toward the circumferential direction when receiving an impact.

Although FIG. 15A and FIG. 15B show the structure of the magnetic bi-directional clutch 33 with the buffer member 41, it is possible to assemble the buffer member 41 with the magnetic bi-directional clutch 22 or the one-way clutch 17.

### Fourth Exemplary Embodiment

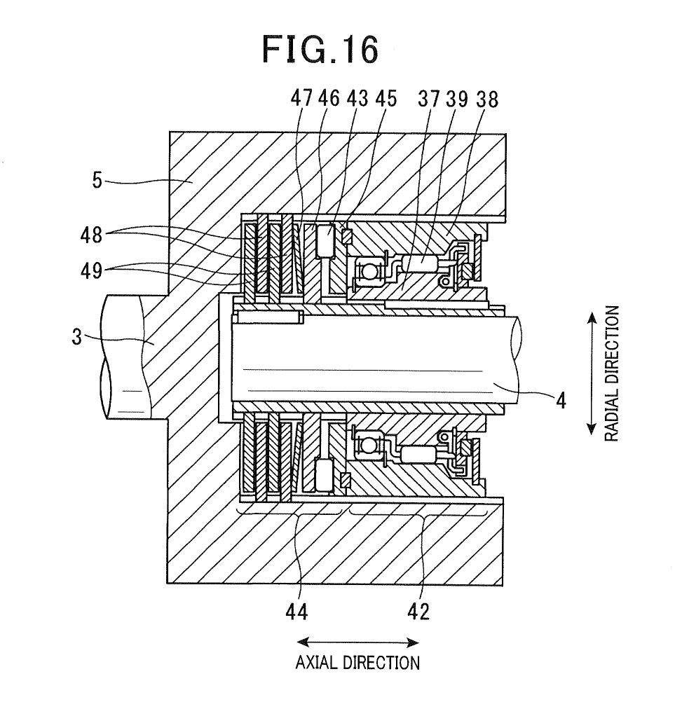

A description will be given of the double drive shaft motor 1 according to the fourth exemplary embodiment with reference to FIG. 16.

FIG. 16 is a schematic cross section showing the rotation limitation section in the double drive shaft motor 1 shown according to the fourth exemplary embodiment.

The first exemplary embodiment discloses the rolling type clutch as the rotation limitation sections as previously described.

On the other hand, as shown in FIG. 16, the fourth exemplary embodiment shows a rotation limitation section (as the third rotation limitation section) having a structure in which a roller 39 is arranged between the inner ring 37 and the outer ring 38.

That is, the third rotation limitation section is comprised of a roller type electromagnetic clutch 42 and a multiple disc clutch 44 (or a multi disc clutch) having a plurality of friction discs as friction members. The roller type electromagnetic clutch 42 prevents the relative rotation between the inner ring 37 and the outer ring 38 when the roller 39 is fitted or meshed between the inner ring 37 and the outer ring 38. The multiple disc clutch 44 converts the rotational force generated by the roller type electromagnetic clutch 42 to a pushing force. The multiple disc clutch 44 prevents the relative rotation between the second rotating shaft 4 and the second rotating shaft 4 by the pushing force which pushes the friction discs.

In more detail, when the roller type electromagnetic clutch 42 prevents the relative rotation between the inner ring 37 and the outer ring 38, the rotational force is supplied to a pushing plate 45 with grooves which moves in an axial direction to the first rotating shaft 3. A relative rotation is generated between the pushing plate 45 and a pressure plate 46 with grooves. The pressure plate 46 with grooves is movable in an axial direction to the second rotating shaft 46. The rotation of the pressure plate 46 is limited to the second rotating shaft 4. The cone shaped roller sandwiched between the pushing plate 45 and the pressure plate 46 is fitted to the cam surface of the pushing plate 45 and the cam surface of the pressure plate 46. The pressure plate 46 is thereby pushed toward an axial direction (at the left side in FIG. 16). As a result, a drive plate 48 is pushed through a Belleville spring or washer by the pushing force from the pressure plate 46. The drive plate 48 becomes in contact with a driven plate 49. This generates friction between the drive plate 48 and the driven plate 49. As a result, the first rotating shaft 3 is connected to the second rotating shaft 4. The first rotating shaft 3 and the second rotating shaft 4 thereby start to rotate together.

The multiple disc clutch 44 has a specific characteristic of gradually executing the engaging when an electromagnetic clutch having a simple structure is turned on/off. Further, because of using an axial drive force, the multiple disc clutch 44 does not always use energy to execute the connection between the first rotating shaft 3 and the second rotating shaft 4, which is different in operation from a clutch which executes the connection by using an oil pressure generated by usual oil pump. Still further, the double drive shaft motor 1 can be easily equipped with the multiple disc clutch 44 therein, and the double drive shaft motor 1 has a compact-size motor because the multiple disc clutch 44 does not require a large oil pipe system and an oil supply circuit, which is different in operation from a clutch which continuously uses the oil pressure generated by the usual oil pump.

### (Modifications)

In the structure of the double drive shaft motor 1 according to the first exemplary embodiment, the magnetic induction rotor 8 is arranged at the radially outer periphery of the field rotor 6. However, the concept of the present invention is not limited by this structure. For example, it is possible to arrange the field rotor 6 at the radially outer periphery of the magnetic induction rotor 8. That is, the magnetic induction rotor 8 is arranged at the radially inner side and the field rotor 6 is arranged at the radially outer side.

Still further, in the structure of the double drive shaft motor 1 according to the first exemplary embodiment, the stator 9 is arranged at the radially outer side of the field rotor 6 and the magnetic induction rotor 8. However, the concept of the present invention is not limited by this structure. For example, it is possible to arrange the stator 9 at the radially inner side of the field rotor 6 and the magnetic induction rotor 8.

Although the first exemplary embodiment shows the first rotation limitation section comprised of the one-way clutch 17. However, the concept of the present invention is not limited by this structure. For example, it is possible to use a combination of the roller type electromagnetic clutch 42 and the multiple disc clutch 44 instead of using the one-way clutch 17.

Still further, although the first exemplary embodiment shows the second rotation limitation section comprised of the magnetic bi-directional clutch 22. However, the concept of the present invention is not limited by this structure. For example, it is possible to use a combination of the roller type electromagnetic clutch 42 and the multiple disc clutch 44 instead of using the magnetic bi-directional clutch 22.

While specific embodiments of the present invention have been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention which is to be given the full breadth of the following claims and all equivalents thereof.

What is claimed is:

1. A double drive shaft motor of a magnetic modulation type comprising:
a field rotor comprising n pole pairs, where n is a natural number, comprised of a north magnetic pole (N pole) and a south magnetic pole (S pole) alternately arranged in a circumferential direction of the field rotor;
a magnetic induction rotor concentrically arranged with a gap at one of a radially outer side and a radially inner side of the field rotor, the magnetic induction rotor comprising k soft magnetic members, where k is a natural number, and the k soft magnetic members making a magnetic path arranged at regular intervals with a gap in a circumferential direction of the magnetic induction rotor;
a stator concentrically arranged with a gap at one of a radially outer side of a first rotor and a radially inner side of a second rotor, and the stator comprising a multi-phase winding whose number of pole pairs being one of a sum and a difference between the number n and the number k, where the first rotor is one of the field rotor and the magnetic induction rotor which is arranged at a radially outer side, and the second rotor is one of the field rotor and the magnetic induction rotor which is arranged at a radially inner side;
a first rotating shaft configured to support the field rotor;
a second rotating shaft configured to support the magnetic induction rotor;
a motor housing casing configured to rotatably support the first rotating shaft and the second rotating shaft;
a first rotation limitation section configured to allow the first rotating shaft to rotate in one rotation direction to the motor housing casing, and to limit the first rotating shaft to rotate in the other rotation direction to the motor housing casing; and
a second rotation limitation section configured to switch between a neutral state and a locked state, where the neutral state allowing the second rotating shaft to rotate in both directions within the motor housing casing, and the locked state preventing the second rotating shaft from rotating in one of both directions within the motor housing casing.

2. The double drive shaft motor according to claim 1, further to comprising a third rotation limitation section arranged between the first rotating shaft and the second rotating shaft, wherein the third rotation limitation section is configured to switch between a direct-connection state and a disconnection state, where the first rotating shaft is directly connected to the second rotating shaft in the direct-connection state connects, and the first rotating shaft is disconnected from the second rotating shaft in the disconnection state.

3. The double drive shaft motor according to claim 1, wherein the first rotation limitation section is a one-way clutch, and the one-way clutch comprises:
an inner ring rotating together with the first rotating shaft;
an outer ring fixed to the motor housing casing; and
a roller arranged between the inner ring and the outer ring, wherein when a reverse rotational force is supplied to the first rotating shaft, the roller is fitted between the inner ring and the outer ring in order to prevent the first rotating shaft from rotating in a reversely rotating direction to a forwardly rotating direction, where the forwardly rotating direction is a direction that results when a vehicle equipped with the double drive shaft motor is forwardly moved.

4. The double drive shaft motor according to claim 1, wherein the second rotation limitation section is a magnetic bi-directional clutch configured to generate a magnetic force to release the neutral state, and to enter the second rotating shaft into the locked state by using a rotational force of the second rotating shaft.

5. The double drive shaft motor according to claim 4, wherein the magnetic bi-directional clutch comprises:
an electromagnet configured to generate magnetic force;
a clutch control section configured to release the second rotating shaft from the neutral state by magnetic force generated by the electromagnet; and
a magnetic induction yoke configured to transmit the magnetic force generated by the electromagnet to the second rotation limitation section.

6. The double drive shaft motor according to claim 2, wherein the third rotation limitation section is a magnetic bi-directional clutch configured to generate a magnetic force to release the disconnection state between the first rotating shaft and the second rotating shaft, and to enter the first rotating shaft and the second rotating shaft into the direct-connection state by using a rotational force of the first rotating shaft.

7. The double drive shaft motor according to claim 6, wherein the magnetic bi-directional clutch comprises:
an electromagnet configured to generate magnetic force;
a clutch control section configured to release the disconnection state between the first rotating shaft and the second rotating shaft by magnetic force generated by the electromagnet; and
a magnetic induction yoke configured to transmit the magnetic force generated by the electromagnet to the clutch control section of the third rotation limitation section.

8. The double drive shaft motor according to claim 7, wherein the stator acts as the electromagnet in the magnetic bi-directional clutch as the third rotation limitation section when the clutch control section release the first rotating shaft and the second rotating shaft from the disconnection state.

9. The double drive shaft motor according to claim 8, wherein a multi-phase alternating current and a zero phase component are supplied to the multi-phase winding of the stator.

10. The double drive shaft motor according to claim 1, wherein at least one of the first rotation limitation section and the second rotation limitation section is equipped with a buffer member configured to adsorb impact caused during the rotation limitation to the first rotating shaft and the second rotating shaft.

11. The double drive shaft motor according to claim 2, wherein the third rotation limitation section is equipped with a buffer member configured to adsorb impact caused when the first rotating shaft is directly connected to the second rotating shaft.

12. The double drive shaft motor according to claim 1, wherein at least one of the first rotation limitation section and the second rotation limitation section comprises:
a roller is arranged between an inner ring and an outer ring;
a roller type electromagnetic clutch to prevent a relative rotation between the inner ring and the outer ring when the roller is mated between the inner ring and the outer ring; and
a multiple disc clutch comprising a plurality of friction members configured to convert a rotational force generated by the roller type electromagnetic clutch to a pressing force, and to press the friction members by the pressing force in order to generate a rotation preventing force to prevent the relative rotation between the inner ring and the outer ring.

13. The double drive shaft motor according to claim 2, wherein the third rotation limitation section comprises:
a roller is arranged between an inner ring and an outer ring;
a roller type electromagnetic clutch to prevent a relative rotation between the inner ring and the outer ring when the roller is mated between the inner ring and the outer ring; and
a multiple disc clutch comprising a plurality of friction members configured to convert a rotational force generated by the roller type electromagnetic clutch to a pressing force, and to press the friction members by the pressing force in order to generate a rotation preventing force to prevent the relative rotation between the inner ring and the outer ring.

14. The double drive shaft motor according to claim 1, wherein the first rotating shaft is connected to an output shaft of an internal combustion engine mounted to a vehicle, the second rotating shaft is connected to a wheel shaft of the vehicle, and
the first rotation limitation section allows the first rotating shaft to rotate the forward rotation direction and prevents the first rotating shaft from rotating a reversely rotating direction which is opposite to the forwardly rotating direction, where the forward rotation direction is a direction to which the first rotating shaft rotates by the power supplied from the internal combustion engine, and
the second rotation limitation section allows the second rotating shaft to rotate in both directions, namely, in bi-directions, the forwardly rotating direction and the reversely rotating direction which is opposite to the forwardly rotating direction, and prevents the second rotating shaft from rotating in one of the forwardly rotating direction and the reversely rotating direction, where the forwardly rotating direction of the second rotating shaft is a direction to which the wheel shaft forwardly rotates, and the reversely rotating direction of the second rotating shaft is a direction to which the wheel shaft reversely rotates.
